(19) United States
(12) Patent Application Publication
(10) Pub. No.: US 2015/0026376 A1
(43) Pub. Date: Jan. 22, 2015

(54) UPGRADEABLE MULTIMEDIA MODULE CONNECTOR

(71) Applicant: CloudCar Inc., Los Altos, CA (US)

(72) Inventors: James Scanlan, San Francisco, CA (US); Zarko Draganic, Belvedere, CA (US); Peter T Barrett, Palo Alto, CA (US)

(73) Assignee: CloudCar Inc., Los Altos, CA (US)

(21) Appl. No.: 14/047,977

(22) Filed: Oct. 7, 2013

Related U.S. Application Data
(63) Continuation-in-part of application No. 29/460,913, filed on Jul. 16, 2013.
Application No. 29/460,913 is a continuation-in-part of application No. 14/047,966, filed on Oct. 7, 2013.

(51) Int. Cl. G06F 13/40

(52) U.S. Cl. CPC G06F 13/4081
USPC 710/300

(57) ABSTRACT

Systems and methods for providing a modular in-vehicle infotainment architecture with an upgradeable multimedia module having a multimedia module connector are disclosed. A particular embodiment includes: providing a male portion of a multimedia module connector including an alignment mechanism; providing a female portion of a multimedia module connector, the female portion being configured with a void corresponding in shape to the alignment mechanism of the male portion, the male portion including a plurality of flat electrically conductive contacts integrated into the male portion, the plurality of contacts being configured to make electrical contact with corresponding flat contacts on the female portion when the male portion is inserted into the void of the female portion, the plurality of contacts including a plurality of radio frequency (RF) contacts for transferring RF signals between the male portion and the female portion, the plurality of contacts further including a plurality of data contacts for transferring data signals between the male portion and the female portion, the plurality of contacts being configured to enable a transfer of RF signals and data signals between a multimedia module and one or more vehicle subsystems of a vehicle; and detachably connecting the male portion to the female portion.

### PRIORITY PATENT APPLICATIONS

This is a continuation-in-part patent application of co-pending U.S. design patent application Ser. No. 29/460,913; filed Jul. 16, 2013 by the same applicant. This is also a continuation-in-part patent application of co-pending U.S. patent application Ser. No. ______; filed ______ by the same applicant. This present patent application draws priority from the referenced patent applications. The entire disclosure of the referenced patent applications is considered part of the disclosure of the present application and is hereby incorporated by reference herein in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the U.S. Patent and Trademark Office patent files or records, but otherwise reserves all copyright rights whatsoever. The following notice applies to the disclosure herein and to the drawings that form a part of this document; Copyright 2012-2013, CloudCar Inc., All Rights Reserved.

### TECHNICAL HELD

This patent document pertains generally to tools (systems, apparatuses, methodologies, computer program products, etc.) for allowing electronic devices to share information with each other, and more particularly, but not by way of limitation, to a modular in-vehicle infotainment architecture with an upgradeable multimedia module.

### BACKGROUND

An increasing number of vehicles are being equipped with one or more independent computer and electronic processing systems. Certain of the processing systems are provided for vehicle operation or efficiency. For example, many vehicles are now equipped with computes systems for controlling engine parameters, brake systems, tire pressure and other vehicle operating characteristics. A diagnostic system may also be provided that collects and stores information regarding the performance of the vehicle's engine, transmission, fuel system and other components. The diagnostic system can typically be connected to an external computer to download or monitor the diagnostic information to aid a mechanic during servicing of the vehicle.

Additionally, other processing systems may be provided for vehicle driver or passenger comfort and/or convenience. For example, vehicles commonly include navigation and global positioning systems and services, which provide travel directions and emergency roadside assistance. Vehicles are also provided with multimedia entertainment systems that include sound systems, e.g., satellite radio, broadcast radio, compact disk and MP3 players and video players. Still further, vehicles may include cabin climate control, electronic seat and mirror repositioning and other operator comfort features. These electronic in-vehicle infotainment (IVI) systems provide digital navigation, information, and entertainment to the occupants of a vehicle.

However, each of the above processing systems is independent, non-integrated and incompatible. That is, such processing systems provide their own sensors, input and output devices, power supply connections and processing logic. Moreover, such processing systems may include sophisticated and expensive processing components, such as application specific integrated circuit (ASIC) chips or other proprietary hardware and/or software logic that are incompatible with other processing systems in the vehicle.

Moreover, there is a widening gap between current smartphone technology and IVI experiences. Phones are typically replaced every year or two, cars every decade or two. Automotive manufacturing requires long lead time, so automotive hardware and software platforms are obsolete by the time they ship. Automotive Original Equipment Manufacturers (OEMs) and Tier 1 suppliers have built navigation and media functions into automotive head units, which are expensive and difficult to upgrade. In most cases, automotive head units are not software or hardware upgradeable and become quickly obsolete when compared to consumer mobile devices or other consumer electronics. Automotive OEMs started offering “cellphone kit” adapters, which were designed for particular brands of cellphones. However, these cellphone kits quickly become obsolete and are limited to only a few functions. Apple™ has the “iPod Out” proprietary standard, which does not handle automotive features or high resolution digital Audio/video, with no means of upgrading.

### BRIEF DESCRIPTION OF THE DRAWINGS

The various embodiments are illustrated by way of example, and not by way of limitation, in the figures of the accompanying drawings in which:

FIG. 1 illustrates a block diagram of an example modular in-vehicle infotainment architecture with an upgradeable multimedia module in which embodiments described herein may he implemented;

FIG. 2 illustrates the components of the multimedia module of an example embodiment;

FIG. 3 is a perspective view of the male portion of the upgradeable multimedia module connector of an example embodiment from the front and from above;

FIG. 4 is a perspective view of the male portion of the upgradeable multimedia module connector of an example embodiment from the front and from below;

FIG. 5 is a view of the right side and the left side mirror view of the male portion of the upgradeable multimedia module connector of an example embodiment;

FIG. 6 is a view of the top side of the male portion of the upgradeable multimedia module connector of an example embodiment;

FIG. 7 is a view of the front side of the male portion of the upgradeable multimedia module connector of an example embodiment;

FIG. 8 is a view of the bottom side of the male portion of the upgradeable multimedia module connector of an example embodiment;

FIG. 9 is a view of the rear side of the male portion of the upgradeable multimedia module connector of an example embodiment;

FIG. 10 is a perspective view of the female portion of the upgradeable multimedia module connector of an example embodiment from the front and from above;

FIG. 11 is a perspective view of the female portion of the upgradeable multimedia module connector of an example embodiment from the front and from below;

FIG. 12 is a view of the right side and the left side mirror view of the female portion of the upgradeable multimedia module connector of an example embodiment;

FIG. 13 is a view of the top side of the female portion of the upgradeable multimedia module connector of an example embodiment;

FIG. 14 is a view of the front side of the female portion of the upgradeable multimedia module connector of an example embodiment;

FIG. 15 is a view of the bottom side of the female portion of the upgradeable multimedia module connector of an example embodiment;

FIG. 16 is a view of the rear side of the female portion of the upgradeable multimedia module connector of an example embodiment;

FIG. 17 is another perspective view of the male portion of the upgradeable multimedia module connector of an example embodiment from the front and from above highlighting the alignment mechanism;

FIG. 18 is a perspective view of the female portion of the upgradeable multimedia module connector of an example embodiment from the front and from above highlighting the alignment mechanism;

FIG. 19 is another perspective view of the male portion of the upgradeable multimedia module connector of an example embodiment from the front and from above highlighting the dielectric tuning notches of the alignment mechanism;

FIGS. 20 and 21 illustrate the anti-fretting contacts of an example embodiment;

FIG. 22 is a process flow chart illustrating an example embodiment of systems and methods for providing an upgradeable multimedia module connector; and

FIG. 23 shows a diagrammatic representation of machine in the example form of a computer system within which a set of instructions when executed may cause the machine to perform any one or more of the methodologies discussed herein.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

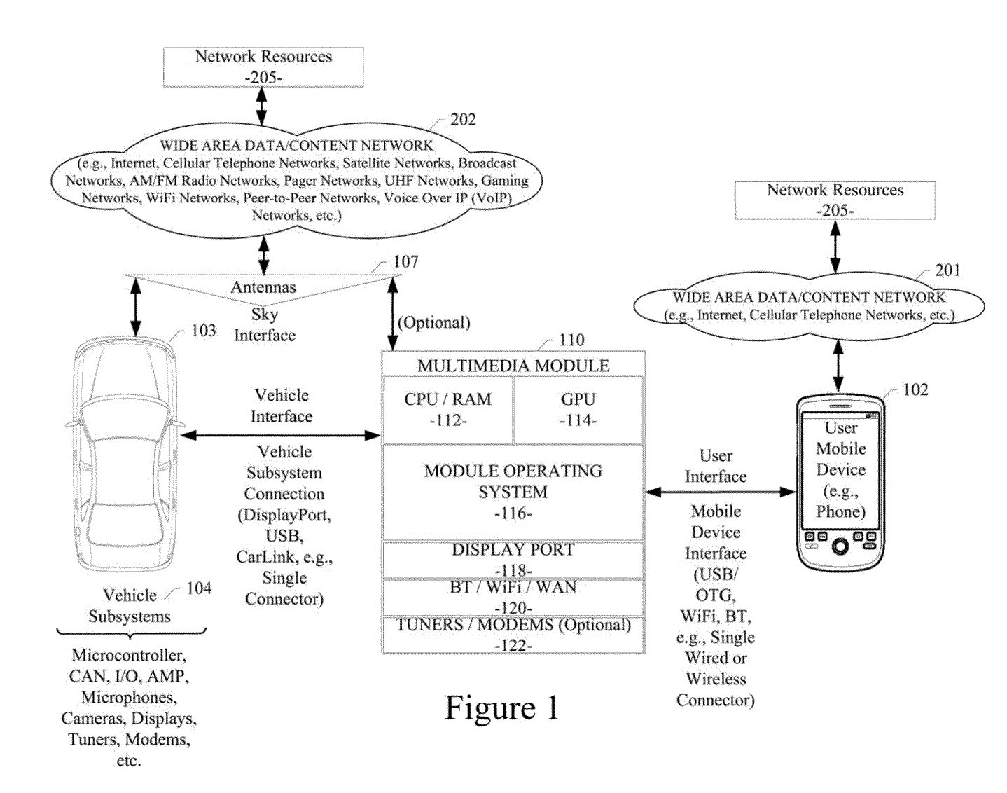

As described in various example embodiments, systems and methods for providing a modular in-vehicle infotainment architecture with an upgradeable multimedia module and a multimedia module connector are described herein. In one example embodiment, the modular in-vehicle infotainment architecture can be configured like the architecture illustrated in FIG. 1. However, it will be apparent to those of ordinary skill in the art that the modular in-vehicle infotainment architecture described and claimed herein can be implemented, configured, and used in a variety of other applications and systems.

Particular example embodiments relate to a new standard modular hardware architecture, were traditional “automotive baseband” elements, such as displays, radio tuners, satellite receivers, cameras, microphones, Controller Area Network (CAN) busses, general input/output signals, such as steering wheel switches and buttons, user-facing Universal Serial Bus (USB) ports are separated from an upgradeable multimedia module included in the modular in-vehicle infotainment architecture as described herein. In one example embodiment, the upgradeable multimedia module runs an Android™ Compatibility Definition Document (CDD) compliant Android™ operating system. The multimedia module is physically separate and has a single detachable connector, which allows the multimedia module to be easily exchanged as media technologies change or improve. The multimedia module can connect to the vehicle with as new detachable connector with a new electro-mechanical design that is described herein. Standardizing an upgradeable multimedia module across automotive manufacturers would allow reduced cost and increased compatibility for fixture technology, allowing more desirable product and service offerings and revenue opportunities as technology progresses.

Referring now to FIG. 1, example embodiments relate to a multimedia module 110 facilitating the communication of data signals and information and the activation of procedures and/or services between mobile devices 102, network resources 205 accessible via network 201, network resources 205 accessible via network 202 and the antennas 107, and vehicle subsystems 104 of a conventional vehicle 103. Embodiments disclosed herein generally provide the multimedia module 110 to enable the communication and control of data signals, information, and services between in-vehicle infotainment (IVI) subsystems of a vehicle, electronic control units (ECUs) of a vehicle, network-based mobile devices 102, such as mobile phones or mobile computing platforms, and network resources 205 accessible via the network 201 or network 202, such as server computers, websites, and the like. These network resources 205 are accessible via a conventional wide area network 201, such as the cellular telephone networks and/or the Internet and/or via a conventional wide area network 202, such as the cellular telephone networks, satellite networks, AM/FM radio networks, pager networks, UHF networks, other broadcast networks, gaming networks, WiFi networks, peer-to-peer networks, Voice Over IP (VoIP) networks, etc., and/or the Internet. In most cases, the cellular telephone networks tend to be more expensive to use than the broadcast networks. For example, it is less expensive and faster to stream media content (e.g., music or video selections) to a device via the broadcast networks as compared with the cellular networks. On the other hand, it is typically more efficient to use the cellular networks for phone calls. However, even among different cellular network providers there are often promotional rates or discounts offered by a particular cellular network provider at a particular point in time that are not offered by other cellular network providers. Thus, the embodiments described herein enable a user/subscriber to configure the system for automatic selection of the preferred network or mode of delivery of content and/or services to vehicle-connected mobile devices.

Generally, FIG. 1 depicts the communication of data signals between (from/to) the vehicle 103 subsystems 104, between the multimedia module 110, and between the mobile device(s) 102. Some of the data signals can he produced at the vehicle subsystems 104. The format of the data signals can be converted at the multimedia module 110, and the data signals can be further processed at the mobile device 102. For example, data signals communicated from the IVI subsystems or the ECUs of the vehicle 103 (e.g., vehicle subsystems 104) to the mobile devices 102 or network resources 205 may include information about the state of one or more of the components of the vehicle 103. In particular, the data signals, which can be communicated from the IVI subsystems or the ECUs to the CAN bus of the vehicle 103, can be received and processed by the multimedia module 110.

FIG. 1 depicts a system that includes a vehicle 103 with various vehicle subsystems 104. The systems and methods described herein can be used with substantially any mechanized system that uses a CAN bus as defined herein, including, but not limited to, industrial equipment, boats, trucks, or automobiles; thus, the term “vehicle” extends to any such mechanized systems. The systems and methods described herein can also be used with any systems employing some form of network data communications.

The data signals communicated between the vehicle subsystems 104 and the multimedia module 110 may be formatted in a vehicle-specific format—i.e., specific to a vehicle 103 make and model. The vehicle-specific format generally refers to the format of the data signals for or from the vehicle subsystems 104. That is, the vehicle subsystems 104 may be manufactured by a first manufacturer that may have a vehicle-specific format for all its vehicle subsystems. Alternatively, the first manufacturer may have a vehicle-specific format for different models, years, option packages, etc. Generally, the vehicle-specific formats of different vehicle subsystems 104 may not be the same. Thus, a vehicle 103 manufactured by the first manufacturer typically has a different vehicle-specific format than a second vehicle 103 manufactured by a second manufacturer. Additionally or alternatively, in some embodiments, the data signals may be differential signals.

The multimedia module 110 couples with a detachable vehicle subsystem connector as part of a vehicle 103 subsystem connection associated with the vehicle subsystems 104. For example, as shown in FIG. 1, the vehicle subsystems 104 may have a single detachable connector that is adapted to connect with (and detach from) a connector of the multimedia module 110. Generally, the interface between the vehicle subsystems 104 and the multimedia module 110 includes a physical connection as well as an electrical interface such that the data signals communicated from/to the vehicle subsystems 104 may be further communicated to/from the multimedia module 110.

As shown in FIG. 1, the vehicle 103 subsystem connection and vehicle interface between the multimedia module 110 and the vehicle subsystems 104 can be implemented in a variety of ways. For example, one embodiment can use a modified DisplayPort interface. DisplayPort is a digital display interface developed by the Video Electronics Standards Association (VESA). The interface is primarily used to connect a video source to a display device such as a computer monitor, though the DisplayPort interface can also be used to transmit audio USB, and other forms of data. As such, a modified DisplayPort interface can be used to manage the in-vehicle infotainment (IVI) subsystems of a vehicle 103 from the multimedia module 110. A DisplayPort module 118 is provided in the multimedia module 110 to support the modified DisplayPort interface. In another embodiment, the interface between the multimedia module 110 and the vehicle subsystems 104 can be implemented using a USB interface and associated connector. USB is an industry standard developed in the mid-1990's that defines the cables, connectors, and communications protocols typically used for connection, communication and power supply between electronic devices. In another embodiment, the interface between the multimedia module 110 and the vehicle subsystems 104 can be implemented using a CarLink interface. Some conventional CarLink interfaces are used to support remotely-startable vehicles. In any of these various embodiments, the vehicle 103 interface enables the multimedia module 110 to access the standard CAN bus in the vehicle 103. As a result, the multimedia module 110 can communicate with IVI subsystems or ECUs (e.g., vehicle subsystems 104) in the vehicle 103.

As shown in FIG. 1, the multimedia module 110 also couples with one or more mobile devices 102 as part of as mobile device interface supporting a user interface on the mobile device 102. In various embodiments, the mobile device interface and user interface between the multimedia module 110 and the mobile devices 102 can he implemented in a variety of ways. For example, in one embodiment, the mobile device interface and user interface between the multimedia module 110 and the mobile devices 102 can be implemented using a USB interface and associated connector. In a preferred configuration, a USB On-The-Go, (USB OTG) interface can be used to enable the mobile devices 102 to act as a host device. USB OTG is as standard specification that allows USB devices such as mobile computing devices or mobile phones to act as a host, allowing other USB devices, like the multimedia module 110, to be attached to and communicate with them.

In another embodiment, the mobile device interface and user interface between the multimedia module 110 and the mobile devices 102 can he implemented using a wireless protocol, such as WiFi or Bluetooth (BT). WiFi is a popular wireless technology allowing an electronic device to exchange data wirelessly over a computer network. Bluetooth is a wireless technology standard for exchanging data over short distances. As shown in FIG. 1, a BT/WiFi/WAN module 120 is provided in the multimedia module 110 to support the WiFi or Bluetooth interface.

Referring still to FIG. 1, the multimedia module 110 can also communicate with network resources 205 via the network 202 and antennas 107. The network 202 represents a conventional cellular telephone network, satellite network, AM/FM radio network, pager network, UHF network, or other wireless broadcast network, gaming network, WiFi network, peer-to-peer network, Voice Over IP (VoIP) network, etc., that can be received in vehicle 103 via one or more antennas 107. Antennas 107 can serve to connect the multimedia module 110 with a data or content network 202 via cellular, satellite, radio, or other conventional signal reception mechanism. Such cellular data or content networks are currently available (e.g., Verizon™, AT&T™, T-Mobile™, etc.). Such satellite-based data or content networks are also currently available (e.g., SiriusXM™, HughesNet™, etc.). The conventional broadcast networks, such as AM/FM radio networks, pager networks, UHF networks, gaming networks, WiFi networks, peer-to-peer networks, Voice Over IP (VOIP) networks, and the like are also well-known. Thus, as described in more detail below, the tuner module 122 of multimedia module 110 can include a radio receiver, a cellular receiver, and/or a satellite-based data or content modem to decode data and/or content signals received via radio signals, cellular signals, and/or satellite. As a result, the multimedia module 110 can obtain a data/content connection with network resources 205 via network 202, which is a connection independent of the data/content connection with network resources 205 via network 201.

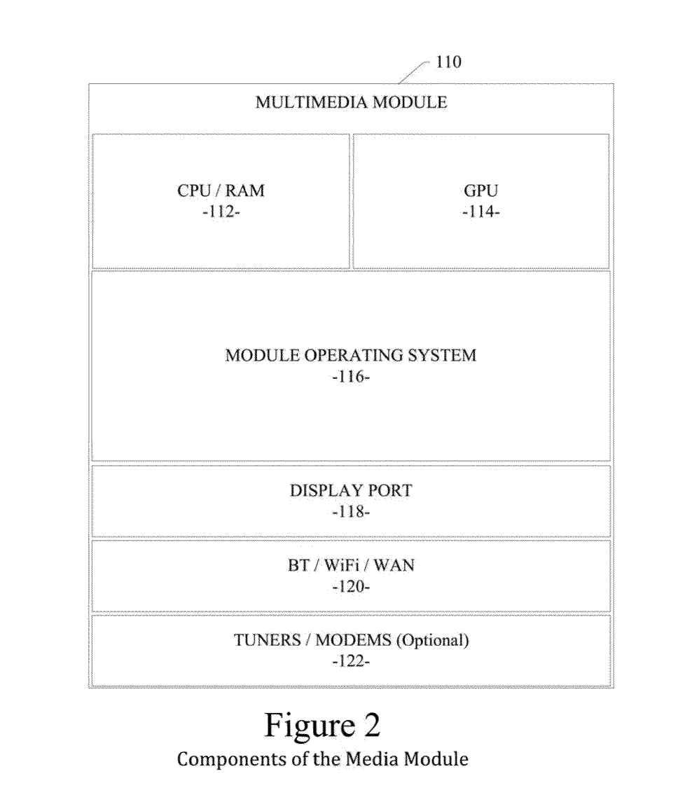

Referring now to FIG. 2, the components of the multimedia module 110 of an example embodiment are illustrated. As described above, the multimedia module 110 can include a Display module 118 to support a modified DisplayPort interface between the vehicle subsystems 104 and the multimedia module 110. Similarly, the multimedia module 110 can include a BT/WiFi/WAN module 120 to support a WiFi or Bluetooth interface between the mobile devices 102 and the multimedia module 110. The multimedia module 110 can also include a central processing unit (CPU) 112 with a conventional random access memory (RAM). The CPU 112 can be implemented with an available microprocessor or application specific integrated circuit (ASIC). The multimedia module 110 can also include a graphics processing unit (GPU) 114 to support image processing of images transferred to the vehicle 103 display and/or other IVI subsystems, or images received from the camera and/or other IVI subsystems. The GPU 114 can be implemented with any conventional graphics processing unit. The multimedia module 110 can also include as module operating system 116, which can be layered upon and executed by the CPU 112 and GPU 114 processing platform. In one example embodiment, the module operating system 116 can he implemented using an Android™ Compatibility Definition Document (CDD) compliant Android™ operating system. It will be apparent to those of ordinary skill in the art that alternative operating systems and processing platforms can be used to implement the multimedia module 110.

Referring still to FIGS. 1 and 2, the multimedia module 110 can convert the data signals generated by a vehicle subsystem 104 from a vehicle-specific format to as mobile device data signal format defined by an Application Programming Interface (API). The multimedia module 110 can then securely and wirelessly (or via USB) transmit the data signals to the mobile device 102 and/or a network resource 205. By converting the data signals to the mobile device 102 format, the mobile device 102 may use the data signals without knowing the vehicle-specific format. Additionally, the mobile device 102 data signal format defined by the API exposes the data signals of the vehicle subsystems 104 (e.g., IVI, ECUs and other vehicle hardware and software) in a standardized way, thereby enabling multiple vendors or software developers to create mobile device applications that execute on the mobile device 102 and process the data signals from/to the vehicle subsystems 104. In the same way, the API can expose the data signals from/to the vehicle subsystems 104 in a standardized way for the network resources 205.

Additionally, a user of the mobile device 102 and/or a network resource 205 can send a write or control signal from the mobile device 102 and/or network resource 205 through the multimedia module 110 to a vehicle subsystem 104 via the CAN bus of the vehicle 103. The write/control signal enables the user of the mobile device 102 and/or network resources 205 to alter the state or monitor the state of one or more components of as vehicle subsystem 104. The write/control signal can be formatted in the mobile device 102 data signal format defined by the API and wirelessly (or via USB) transmitted to the multimedia module 110. The multimedia module 110 can convert the write/control signal to the vehicle-specific format and communicate the write/control signal to the appropriate component of a vehicle subsystem 104. By converting the write/control signal from the mobile device format defined by the API to the vehicle-specific format, the multimedia module 110 supports an interface with multiple vehicle 103 subsystems and multiple types of vehicles 103. Additionally, the mobile device 102 data signal format defined by the API acts as a common programming language enabling multiple vendors to write mobile device 102 applications and/or network resource 205 applications that may communicate read/monitor and write/control signals to/from multiple types of vehicle 103 subsystems and multiple types of vehicles independent of the model or manufacturer.

Referring again to FIGS. 1 and 2, the multimedia module 110 can optionally include a tuner or modem module 122. The optional tuner module 122 can include one or more radio tuners or modems that can generate audio or video streams, which can be played through IVI components of a vehicle subsystem 104. The multimedia module 110 can also optionally include one or more antennas 107, which can support the reception of wireless audio or video programming by the tuner module 122. Additionally, antenna 107 can serve to connect the multimedia module 110 with a data or content network via radio, cellular, and/or satellite signals. Thus, the tuner module 122 can include a radio receiver, cellular signal receiver, and/or a satellite-based data or content modem to decode data and/or content signals received via radio signals, cellular signals, and/or satellite. As a result, the multimedia module 110 of an example embodiment can source audio/video content, image/graphical content, or information content for IVI components of a vehicle subsystem 104 from mobile devices 102, network resources 205 via network 201, or network resources 205 via network 202 and its cellular network sources, radio network sources, and/or satellite/wireless broadcast sources directly via tuner/modem module 122 and an associated antenna 107. This content can be formatted for a particular vehicle subsystem 104 by the multimedia module 110 and transferred to the particular vehicle subsystem 104 via the vehicle interface described above.

In the example embodiment, the software components of the multimedia module 110 (e.g., the DisplayPort module 118, BT/WiFi/WAN module 120, and the module operating system 116) can be dynamically upgraded, modified, and/or augmented by use of the data connection with the mobile device 102 and the network resources 205. The multimedia module 110 can periodically query a network resource 205 for updates or updates can be pushed to the multimedia module 110.

As used herein, the term “CAN bus,” refers to any bus or data communications system used in a vehicle 103 for communicating signals between an IVI system, ECUs, or other vehicle 103 components. The CAN bus may be a bus that operates according to versions of the CAN specification, but is not limited thereto. The term “CAN bus” can therefore refer to buses or data communications systems that operate according to other specifications, including those that might be developed in the future.

As used herein and unless specified otherwise, the term “mobile device” includes any computing or communications device that can communicate with the multimedia module 110 described herein to obtain read or write access to data signals, messages, or content communicated on a CAN bus or via any other mode of inter-process data communications. In many cases, the mobile device 102 is as handheld, portable device, such as a smart phone, mobile phone, cellular telephone, tablet computer, laptop computer, display pager, radio frequency (RF) device, infrared (IR) device, global positioning device (GPS), Personal Digital Assistants (PDA), handheld computers, wearable computer, portable game console, other mobile communication and/or computing device, or an integrated device combining one or more of the preceding devices, and the like. Additionally, the mobile device 102 can be a computing device, personal computer (PC), multiprocessor system, microprocessor-based or programmable consumer electronic device, network PC, diagnostics equipment, a system operated by a vehicle 103 manufacturer or service technician, and the like, and is not limited to portable devices. The mobile device 102 can receive and process data in any of a variety of data formats. The data format may include or be configured to operate with any programming format, protocol, or language including, but not limited to, JavaScript, C++, iOS, Android, etc.

As used herein and unless specified otherwise, the term “network resource” includes any device, system, or service that can communicate with the multimedia module 110 described herein to obtain read or write access to data signals, messages, or content communicated on a CAN bus or via any other mode of inter-process or networked data communications. In many cases, the network resource 205 is a data network accessible computing platform, including client or server computers, websites, mobile devices, peer-to-peer (P2P) network nodes, and the like. Additionally, the network resource 205 can be a web appliance, a network router, switch, bridge, gateway, diagnostics equipment, a system operated by a vehicle 103 manufacturer or service technician, or any machine capable of executing a set of instructions (sequential or otherwise) that specify actions to be taken by that machine. Further, while only a single machine is illustrated, the term “machine” can also be taken to include any collection of machines that individually or jointly execute a set (or multiple sets) of instructions to perform any one or more of the methodologies discussed herein. The network resources 205 may include any of a variety of providers or processors of network transportable digital content. Typically, the file format that is employed is Extensible Markup Language (XML), however, the various embodiments are not so limited, and other file formats may be used. For example, data formats other than Hypertext Markup Language (HTML)/XML or formats other than open/standard data formats can be supported by various embodiments. Any electronic file format, such as Portable Document Format (PDF), audio (e.g., Motion Picture Experts Group Audio Layer 3—MP3, and the like), video (e.g., MP4, and the like), and any proprietary interchange format defined by specific content sites can he supported by the various embodiments described herein.

The wide area data networks 201 and 202 (also denoted the network cloud) used with the network resources 205 can he configured to couple one computing or communication device with another computing or communication device. The network may be enabled to employ any form of computer readable data or media for communicating information from one electronic device to another. The network 201 can include the Internet in addition to other wide area networks (WANs), cellular telephone networks, metro-area networks, local area networks (LANs), other packet-switched networks, circuit-switched networks, direct data connections, such as through a universal serial bus (USB) or Ethernet port, other forms of computer-readable media, or any combination thereof. The network 202 can include the Internet in addition to other wide area networks (WANs), cellular telephone networks, satellite networks, over-the-air broadcast networks, AM/FM radio networks, pager networks, UHF networks, other broadcast networks, gaming networks, WiFi networks, peer-to-peer networks, Voice Over IP (VoIP) networks, metro-area networks, local area networks (LANs), other packet-switched networks, circuit-switched networks, direct data connections, such as through a universal serial bus (USB) or Ethernet port, other forms of computer-readable media, or any combination thereof. On an interconnected set of networks, including those based on differing architectures and protocols, a router or gateway can act as a link between networks, enabling messages to be sent between computing devices on different networks. Also, communication links within networks can typically include twisted wire pair cabling, USB, Firewire, Ethernet, or coaxial cable, while communication links between networks may utilize analog or digital telephone lines, full or fractional dedicated digital lines including T1, T2, T3, and T4, Integrated Services Digital Networks (ISDNs), Digital User Lines (DSLs), wireless links including satellite links, cellular telephone links, or other communication links known to those of ordinary skill in the art. Furthermore, remote computers and other related electronic devices can be remotely connected to the network via a modem and temporary telephone link.

The networks 201 and 202 may further include any of a variety of wireless sub-networks that may further overlay stand-alone ad-hoc networks, and the like, to provide an infrastructure-oriented connection. Such sub-networks may include mesh networks, Wireless LAN (WLAN) networks, cellular networks, and the like. The network may also include an autonomous system of terminals, gateways, routers, and the like connected by wireless radio links or wireless transceivers. These connectors may be configured to move freely and randomly and organize themselves arbitrarily, such that the topology of the network may change rapidly.

The networks 201 and 202 may further employ a plurality of access technologies including 2nd (2G), 2.5, 3rd (3G), 4th (4G) generation radio access for cellular systems, WLAN, Wireless Router (WR) mesh, and the like. Access technologies such as 2G, 3G, 4G, and future access networks may enable wide area coverage for mobile devices, such as one or more of client devices, with various degrees of mobility. For example, the network may enable a radio connection through a radio network access, such as Global System for Mobile communication (GSM), General Packet Radio Services (GPRS). Enhanced Data GSM Environment (EDGE), Wideband Code Division Multiple Access (WCDMA), CDMA2000, and the like. The network may also be constructed for use with various other wired and wireless communication protocols, including TCP/IP, UDP, SIP, SMS, RTP, WAP, CDMA, TDMA, EDGE, UMTS, GPRS, GSM, UWB, WiMax, IEEE 802.11x, and the like. In essence, the networks 201 and 202 may include virtually any wired and/or wireless communication mechanisms by which information may travel between one computing device and another computing device, network, and the like.

In a particular embodiment, a mobile device 102 and/or a network resource 205 may act as a client device enabling a user to access and use the multimedia module 110 to interact with one or more components of as vehicle subsystem 104. These client devices 102 or 205 may include virtually any computing device that is configured to send and receive information over a network, such as networks 201 and 202 as described herein. Such client devices may include mobile devices, such as cellular telephones, smart phones, tablet computers, display pagers, radio frequency (RF) devices, infrared (IR) devices, global positioning devices (GPS), Personal Digital Assistants (PDAs), handheld computers, wearable computers, game consoles, integrated devices combining one or more of the preceding devices, and the like. The client devices may also include other computing devices, such as personal computers (PCs), multiprocessor systems, microprocessor-based or programmable consumer electronics, network PC's, and the like. As such, client devices may range widely in terms of capabilities and features. For example, a client device configured as a cell phone may have a numeric keypad and a few lines of monochrome LCD display on which only text may be displayed. In another example, a web-enabled client device may have a touch sensitive screen, a stylus, and a color LCD display screen in which both text and graphics may be displayed. Moreover, the web-enabled client device may include a browser application enabled to receive and to send wireless application protocol messages (WAP), and/or wired application messages, and the like. In one embodiment, the browser application is enabled to employ HyperText Markup Language (HTML), Dynamic HTML, Handheld Device Markup Language (HDML), Wireless Markup Language (WML), WMLScript, JavaScript, EXtensible HTML (xHTML), Compact HTML (CHTML), and the like, to display and send a message with relevant information.

The client devices may also include at least one client application that is configured to receive content or messages from another computing device via a network transmission. The client application may include a capability to provide and receive textual content, graphical content, video content, audio content, alerts, messages, notifications, and the like. Moreover, the client devices may be further configured to communicate and/or receive a message, such as through a Short Message Service (SMS), direct messaging (e.g., Twitter), email, Multimedia Message Service (MMS), instant messaging (IM), internet relay chat (IRC), mIRC, Jabber, Enhanced Messaging Service (EMS), text messaging, Smart Messaging, Over the Air (OTA) messaging, or the like, between another computing device, and the like. The client devices may also include a wireless application device on which a client application is configured to enable a user of the device to send and receive information to/from network resources wirelessly via the network.

Multimedia module 110 can be implemented using systems that enhance the security of the execution environment, thereby improving security and reducing the possibility that the multimedia module 110 and the related services could he compromised by viruses or malware. For example, multimedia module 110 can he implemented using a Trusted Execution Environment, which can ensure that sensitive data is stored, processed, and communicated in a secure way.

As stated above, the multimedia module 110 may receive data signals from the vehicle subsystems 104 that can he converted to a particular mobile device 102 format and/or a network resource 205 format defined by the API. The multimedia module 110 may then communicate the data signals formatted in the mobile device format to the mobile device 102. More specifically, in one example embodiment, the multimedia module 110 may be configured to wirelessly communicate the data signals in the mobile device format to the mobile device 102. The multimedia module 110 may include several configurations. Additionally in some embodiments, the multimedia module 110 may establish a secure channel between the multimedia module 110 and the mobile device 102. In addition to or as an alternative to the secure channel, the multimedia module 110 may encrypt the data signals formatted in the mobile device format. The mobile device 102 may decrypt the data signals. The inclusion of the secure channel and/or encryption may enhance security of the data signals communicated to the mobile device 102.

In embodiments in which the multimedia module 110 wirelessly communicates the data signals to the mobile device 102, the multimedia module 110 and the mobile device 102 can include wireless capabilities such as Bluetooth, Wi-Fi, 3G, 4G, LTE, etc. For example, if the multimedia module 110 includes a Bluetooth transceiver as part of the BT/WiFi/WAN module 120, the multimedia module 110 can communicate wirelessly with the mobile device 102 using Bluetooth capabilities. Generally, the mobile device 102 includes one or more mobile device applications that process the data signals from/for the multimedia module 110. The mobile device applications can produce a user interface with which a user may monitor and control the operation of vehicle subsystems 104 via the multimedia module 110 and the mobile device 102. The mobile device application may be loaded, downloaded, or installed on the mobile device 102 using conventional processes. Alternatively, the mobile device 102 may access a mobile device application via the network cloud 201, for example. The mobile device application may also be accessed and used as a Software as a Service (SaaS) application. The mobile device application may be written or created to process data signals in the mobile device 102 format rather than the vehicle-specific format. Accordingly, the mobile device application may be vehicle-agnostic. That is, the mobile device application may process data signals from any vehicle subsystem 104 once the data signals formatted in the vehicle-specific format are converted by the multimedia module 110.

By processing the data signals from the multimedia module 110 and the vehicle subsystems 104, the mobile device application may function better than a mobile device application without the data signals or may be able to provide functionality not possible without the data signals. For example, the mobile device applications may include a multimedia application. With the inclusion of the multimedia module 110 connected to the vehicle subsystems 104 as described herein, the multimedia application in the mobile device 102 may be used to monitor and control the IVI system in a vehicle 103.

Additionally or alternatively, the mobile device application may enable abstraction of data signals for aggregate uses. For some aggregate uses, the mobile device application may sync with one or more secondary systems (not shown). For example, the mobile device 102 may abstract data signals related to usage of the IVI system in a vehicle 103. The mobile device 102 may communicate with a secondary system that determines media consumption patterns based on the usage of the IVI system in the vehicle 103.

Examples of the mobile device applications are not limited to the above examples. The mobile device application may include any application that processes, abstracts, or evaluates data signals from the vehicle subsystems 104 or transmits write/control signals to the vehicle subsystems 104.

### Upgradeable Multimedia Module Connector

The various embodiments of the upgradeable multimedia module connector as described herein provide a low cost system and method to pass radio frequency (RF) signals in combination with data signals across an electrical connector interface. Conventional connectors that combine data and RF signals are expensive (e.g., the DB13W3 connector). The various embodiments described herein provide improved results at lower cost with additional features and benefits not provided by conventional connectors.

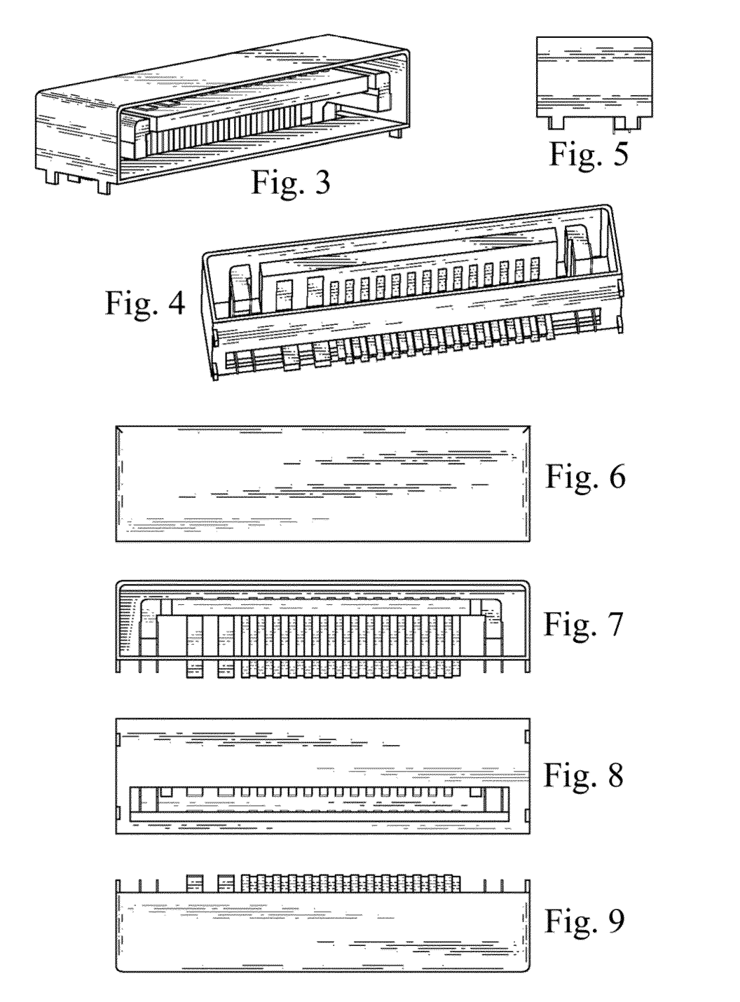

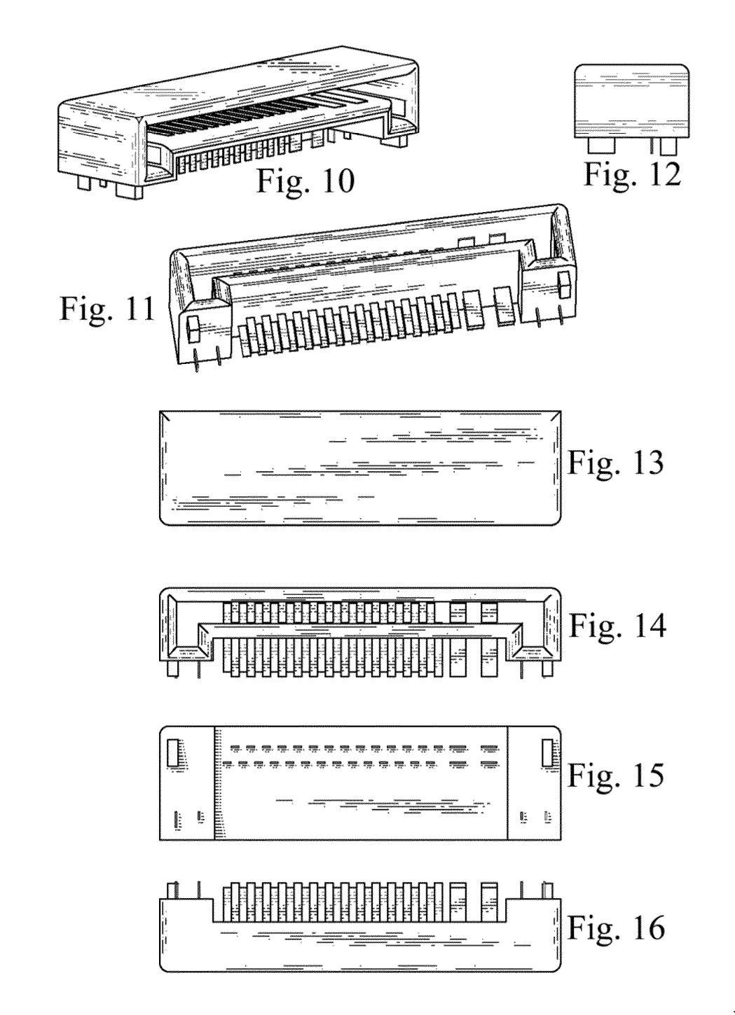

FIG. 3 is a perspective view of the male portion of the upgradeable multimedia module connector of an example embodiment from the front and from above. FIG. 4 is a perspective view of the male portion of the upgradeable multimedia module connector of an example embodiment from the front and from below. FIG. 5 is a view of the right side and the left side mirror view of the male portion of the upgradeable multimedia module connector of an example embodiment. FIG. 6 is a view of the top side of the male portion of the upgradeable multimedia module connector of an example embodiment. FIG. 7 is a view of the front side of the male portion of the upgradeable multimedia module connector of an example embodiment. FIG. 8 is a view of the bottom side of the male portion of the upgradeable multimedia module connector of an example embodiment. FIG. 9 is a view of the rear side of the male portion of the upgradeable multimedia module connector of an example embodiment. FIG. 10 is a perspective view of the female portion of the upgradeable multimedia module connector of an example embodiment from the front and from above. FIG. 11 is a perspective view of the female portion of the upgradeable multimedia module connector of an example embodiment from the front and from below. FIG. 12 is a view of the right side and the left side mirror view of the female portion of the upgradeable multimedia module connector of an example embodiment. FIG. 13 is a view of the top side of the female portion of the upgradeable multimedia module connector of an example embodiment. FIG. 14 is a view of the front side of the female portion of the upgradeable multimedia module connector of an example embodiment. FIG. 15 is a view of the bottom side of the female portion of the upgradeable multimedia module connector of an example embodiment. FIG. 16 is a view of the rear side of the female portion of the upgradeable multimedia module connector of an example embodiment.

In the connector embodiments shown in FIGS. 3 through 16, the male and female portions of the connector provide an alignment mechanism to assist in the proper insertion of the male portion into the female portion. RF connectors using flat conductors are provided on the left and right sides of the alignment mechanism. The alignment mechanism also serves as a dielectric and helps to maintain a desired impedance for the RF signals transiting the connector. These features of the connector embodiments are described in more detail below.

In an example embodiment, the hardware interface between the multimedia module 110 and the vehicle subsystems 104 can be implemented as a modified DisplayPort interface configured in the physical connector illustrated in FIGS. 3 through 16. As described in more detail below, a DisplayPort interface is combined with a USB interface to provide a dual role hardware interface in support of data communications between the multimedia module 110 and the vehicle subsystems 104. As a result, an upgradeable module external connector is provided.

Conventional DisplayPort is a digital display interface developed by the Video Electronics Standards Association (VESA). The interface is primarily used to connect a video source to a display device, such as a computer monitor, though the interface can also be used to transmit audio, video, and other forms of data. DisplayPort is generally a multimedia interface that relies on packetized data transmission, a form of digital communication found in other technologies like Ethernet, USB, and PCI Express. DisplayPort allows both internal and external display connections. Unlike legacy standards where differential pairs are fixed to transmitting a clock signal with each output, the DisplayPort protocol is based on small data packets known as micro packets which can embed the clock signal within the data stream. The advantage is a lower number of pins to achieve higher resolutions. The use of data packets also allows for DisplayPort to be extensible, meaning additional features can be added over time without significant changes to the physical interface itself. As a result, a DisplayPort interface can be beneficial for controlling an IVI subsystem. DisplayPort can be used to transmit audio and video simultaneously, but each one is optional and can be transmitted without the other. The video signal path can have 6 to 16 bits per color channel, and the audio path can have up to 8 channels of 24 bit 192 kHz uncompressed PCM audio, which can encapsulate compressed audio formats in the audio stream. A bi-directional, half-duplex auxiliary channel carries device management and device control data for the Main Data Link, such as VESA EDID, MCCS, and DPMS standards. In addition, the interface is capable of carrying bi-directional USB signals.

The standard DisplayPort interface includes a forward data link channel with one to four lanes for data communications and as bidirectional half-duplex AUX (auxiliary) channel. The standard DisplayPort connector provides a total of 20 pins for the hardware interface. However, the hardware interface in an example embodiment described herein modifies the standard DisplayPort connector to provide a USB 3.0 interface in combination with the DisplayPort interface in a total of 24 pins for the hardware interface.

The USB portion of the hardware interface of an example embodiment supports a conventional USB interface. USB (Universal Serial Bus) is an industry standard data communications interface and protocol developed in the mid-1990s that defines the cables, connectors, and communications protocols used in a bus for connection, communication and power supply between computers and electronic devices. USB was designed to standardize the connection of electronic devices and support communications while supplying electric power. USB 3.0 is the successor of the earlier USB 2.0, USB 3.0 reduces the time required for data transmission, reduces power consumption, and is backward compatible with USB 2.0. The USB 3.0 interface includes four additional pins on the hardware interface to support the super speed receiver (STDA_SSRX+−) and the super speed transmitter (STDA_SSTX+−) interfaces provided by the USB 3.0 specification. In the example embodiment, the USB 3.0 interface is incorporated into the hardware interface of the modified DisplayPort interface of an example embodiment.

In an example embodiment, the pinouts for the modified DisplayPort external connector (source-side) on a printed circuit board (PCB) mounted in the vehicle are listed below. FIGS. 3 through 16 illustrate an example embodiment of the physical structure or housing of the 24-pin external connector. Pluralities of electrically conductive pins are integrated into the housing to provide an electrical pathway for data signals transiting the connector interface. In one embodiment, the physical structure or housing of the 24-pin external connector includes a particular keying structure to enable only similarly keyed connectors to be inserted into the external connector of an example embodiment. In one embodiment, the electrical conductors or contacts in the male and female portions of the connector are implemented using an anti-fretting contact configuration. The anti-fretting contact features of an example embodiment are described in more detail below. The external connector (including both male and female portions) can be used to connect the multimedia module 110 with a corresponding connector on a PCB or data cable in the vehicle. As a result, the external connector of an example embodiment enables the multimedia module 110 to be in data communication with the vehicle subsystems 104 of the vehicle. Moreover, the single connector configuration of an example embodiment provides an easily attached/detached multimedia module 110, which provides an easily upgradeable multimedia module 110 for any type of vehicle.

The pinouts for the modified DisplayPort upgradeable module external connector in an example embodiment follow:

Pin 1: Lane 0 (positive); DisplayPort

Pin 2: Lane 0 (negative); DisplayPort

Pin 3: Lane 1 (positive); DisplayPort

Pin 4: Lane 1 (negative); DisplayPort

Pin 5: Lane 2 (positive); DisplayPort

Pin 6: Lane 2 (negative); DisplayPort

Pin 7: Lane 3 (positive); DisplayPort

Pin 8: Lane 3 (negative); DisplayPort

Pin 9: Auxiliary Channel (positive); DisplayPort

Pin 10: Auxiliary Channel (negative); DisplayPort

Pin 11: Return for Power; DisplayPort

Pin 12: Hot Plug Detect; DisplayPort

Pin 13: +5VDC Power; USB

Pin 14: Data (positive); USB

Pin 15: Data (negative); USB

Pin 16: Ground

Pin 17: STDA_SSRX−; USB

Pin 18: STDA_SSRX+; USB

Pin 19: STDA_SSTX+; USB

Pin 20: STDA_SSTX−; USB

Pin 21: Expansion 1

Pin 22: Expansion 2

Pin 23: Expansion 3

Pin 24: Expansion 4

Note that the pinout listed above is for the multimedia module/vehicle source-side connector. The hardware interface includes four additional pins (21-24), which can be used to support future expansion. It will be apparent to those of ordinary skill in the art in view of the disclosure herein that the pinouts of a particular embodiment of the connector described herein can be implemented using a different quantity or arrangement of pins. Additionally, it will be apparent to those of ordinary skill in the art in view of the disclosure herein that the connector described herein can be used in applications other than as a multimedia module connector.

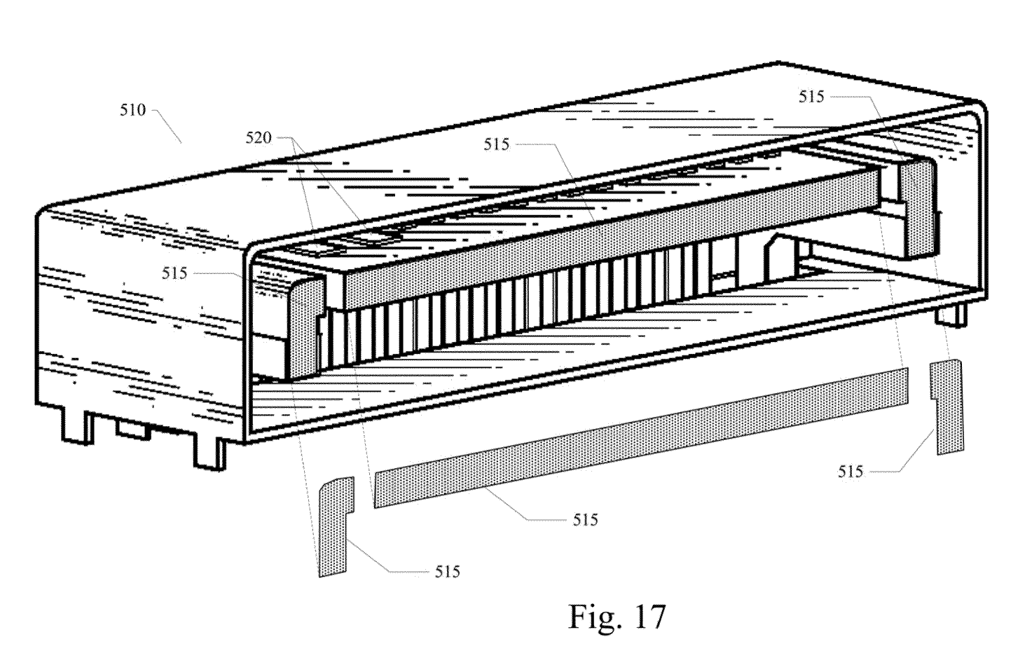

Referring now to FIG. 17, another perspective view of the male portion 510 of the upgradeable multimedia module connector of an example embodiment is shown from the front and from above highlighting the alignment mechanism. In the example connector embodiments described herein, the male and female portions of the connector provide an alignment mechanism to assist in the proper insertion of the male portion into the female portion. RF connectors using flat conductors or contacts are provided on the left and right sides of the alignment mechanism. As described in more detail below, the alignment mechanism also serves as a dielectric and helps to maintain a desired impedance for the RF signals transiting the connector.

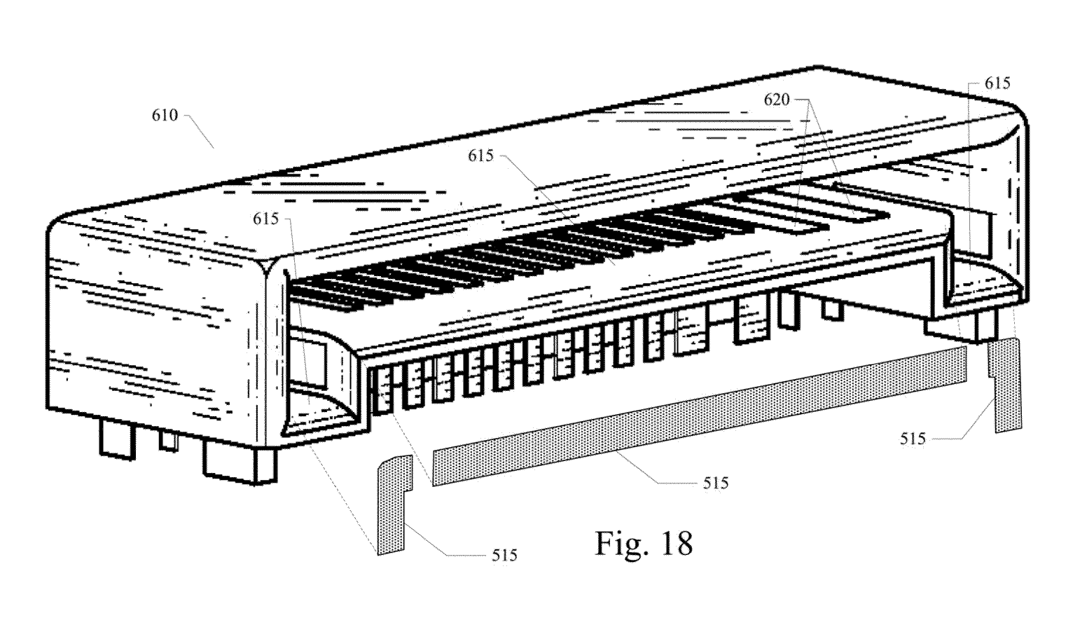

Referring again to FIG. 17, the male portion 510 of the connector provides an alignment mechanism 515 in the general shape of an upside down “U” as represented by the highlighted portion of the alignment mechanism 515 shown in FIG. 17. The alignment mechanism 515 provides sufficient surface area and radiused edges to facilitate easy alignment and insertion of the male portion 510 into a corresponding upside down “U” shaped void 615 of the female portion 610 of the connector as shown in FIG. 18. The long and wide flat contacts 520 on the male portion 510 are configured to make electrical contact with corresponding contacts 620 on the female portion 610 when the male portion 510 is inserted into the void 615 of the female portion 610. As described above, a portion on the contacts of the connector are configured for transmission of RF signals, while another portion of the contacts of the connector are configured for transmission of data signals. By virtue of the physical layout, arrangement, and sizing of the contacts of the connector of an example embodiment, the RF signal contacts can transmit RF signals from one device to another across the male and female portions of the connector with minimal insertion loss, crosstalk, and radiation while maintaining a desired characteristic impedance to the radio signals. The connector of an example embodiment can realize these benefits in the transmission of RF signals across the connector while maintaining a low cost of fabrication of the connector. For example, the connector described herein does not require the use of traditional coaxial connectors, which are machined and expensive to produce. Additionally, only one portion of the connector is shielded in the example embodiment, which further reduces the costs of fabrication of the connector. Moreover, all or most of the conductors in the connector can be equal thickness, making stamping a low cost method of producing the contacts. No machining of pins is required. Finally, the RF conductors in the connector are arranged such that any electrical fields generated by the RF signals are perpendicular to any electrical fields generated by the data or power signals. In this manner, the connector can combine RF signals and data signals on the same connector without degrading the strength and purity of the data signals.

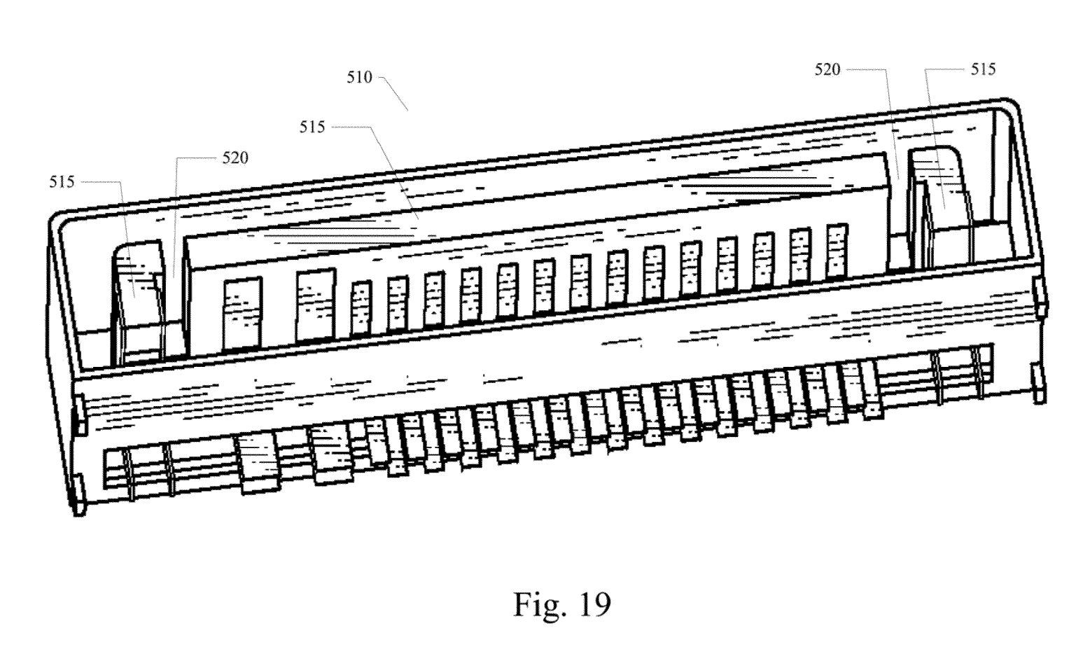

Referring now to FIG. 19, another perspective view of the male portion 510 of the upgradeable multimedia module connector of an example embodiment is shown from the front and from above highlighting the dielectric tuning notches 520 of the alignment mechanism 515. In an example embodiment, the alignment mechanism 515 provides the dielectric for the RF signal pairs on the connector portion 510. For this purpose, the alignment mechanism 515 is configured to include dielectric tuning notches 520. Much like a Planar Inverted-F antenna (PIFA), optional notches 520 in the alignment feature 515 can he used to tune the impedance of the connector RF signal channels without affecting physical alignment of the connector portions. FIG. 19 illustrates an example embodiment showing such dielectric tuning notches 520, which can be used to tune the capacitance between the RF pins and the other pins (e.g., return signal pins) and/or ground of the connector. In various embodiments, the sizing and dimensionality of the tuning notches 520 can be varied to achieve a desired characteristic impedance of the connector. The average dielectric value between the signal and return pins is the volumetric ratio of the free space of the notch as proportional to the volume of plastic or other material from which the physical housing of the connector is fabricated. In many eases, this volumetric ratio can typically be three to five times the volume of the free space.

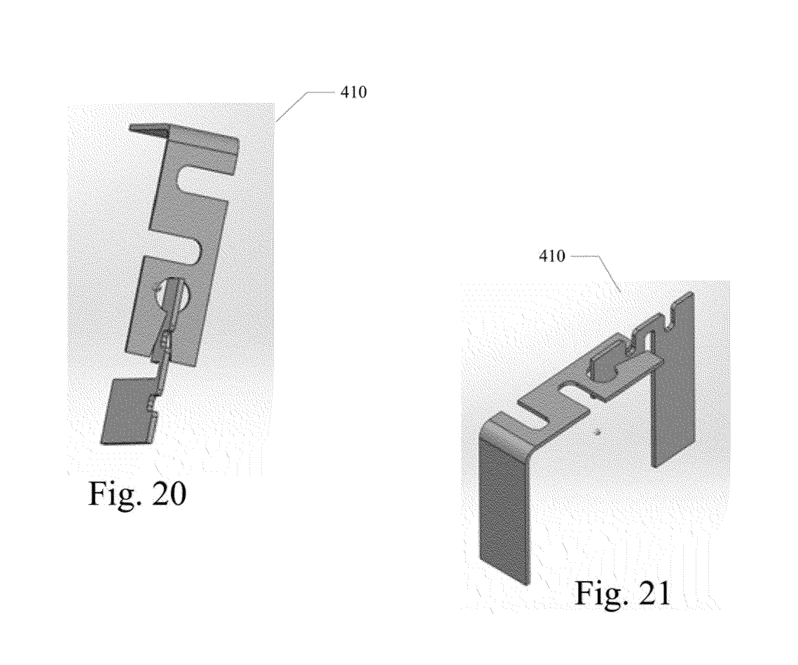

FIGS. 20 and 21 illustrate the anti-fretting contacts 410 of an example Embodiment. In the example embodiment, the electrical conductors or contacts in the male 510 and female 610 portions of the connector are implemented using an anti-fretting contact configuration. As well known to those of ordinary skill in the art, fretting is the increased resistance in an electrical connection caused by vibration that results in inter-connector movement. FIGS. 20 and 21 illustrate an embodiment of optional anti-fretting contacts 410 that may be used to reduce fretting in the connector as described herein. The anti-fretting contacts utilize force-preload and compliant structures to prevent reversing, movement at the connector contact area. These anti-fretting contacts can be produced at low cost, only requiring one dimensional features at the connection portion of the contact. As a result, low cost stamping, laser cutting, or similar processes Can be used to manufacture the contacts. This is possible because the contacts are configured to mate together on orthogonal planes as shown in FIGS. 20 and 21. Other conventional electrical contacts are for wire-to-wire use only, or require the subsequent creation of a two dimensional feature in the contact by curling or crimping the stamped structure in the manufacturing or assembly process. This makes these conventional electrical contacts more expensive to produce. The example embodiments of the connector described herein can use these anti-fretting contacts in the male and female portions of the connector. The anti-fretting contacts on each portion of the connector engage when the connector portions are coupled together. As a result, as non-fretting electrical connection is made.

The upgradeable module external connector described above supports the interface between the multimedia module 110 and the vehicle subsystems 104. The interface between the multimedia module 110 and the user mobile device 102, as shown in FIG. 1, can be implemented using a standard connector or standard interface and protocol. For example, as described above in an example embodiment, the mobile device interface and user interface between the multimedia module 110 and the mobile devices 102 can be implemented using a USB interface and associated connector. In a preferred configuration, a USB On-The-Go, (USB OTG) interface can be used to enable the mobile devices 102 to act as a host device, USB OTG is a standard specification that allows USB devices such as mobile computing devices or mobile phones to act as a host, allowing other USB devices, like the multimedia module 110, to be attached to and communicate with them. In another embodiment, the mobile device interface and user interface between the multimedia module 110 and the mobile devices 102 can be implemented using a wireless protocol, such as WiFi or Bluetooth (BT). In each case, the interface between the multimedia module 110 and the user mobile device 102 can be implemented using standard technologies.

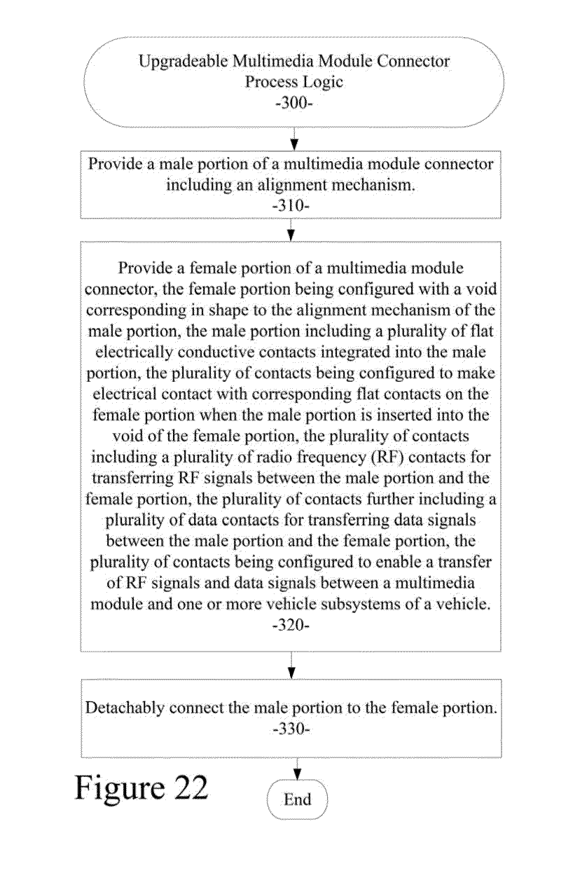

FIG. 22 is a process flow diagram illustrating an example embodiment 300 of a process for providing an upgradeable multimedia module with a multimedia module connector as described herein. The method of an example embodiment includes: providing a male portion of a multimedia module connector including an alignment mechanism (processing block 310); providing a female portion of a multimedia module connector, the female portion being configured with a void corresponding in shape to the alignment mechanism of the male portion, the male portion including a plurality of fiat electrically conductive contacts integrated into the male portion, the plurality of contacts being configured to make electrical contact with corresponding flat contacts on the female portion when the male portion is inserted into the void of the female portion, the plurality of contacts including a plurality of radio frequency (RF) contacts far transferring RF signals between the male portion and the female portion, the plurality of contacts further including a plurality of data contacts for transferring data signals between the male portion and the female portion, the plurality of contacts being configured to enable a transfer of RF signals and data signals between a multimedia module and one or more vehicle subsystems of a vehicle (processing block 320); and detachably connecting the male portion to the female portion (processing block 330).

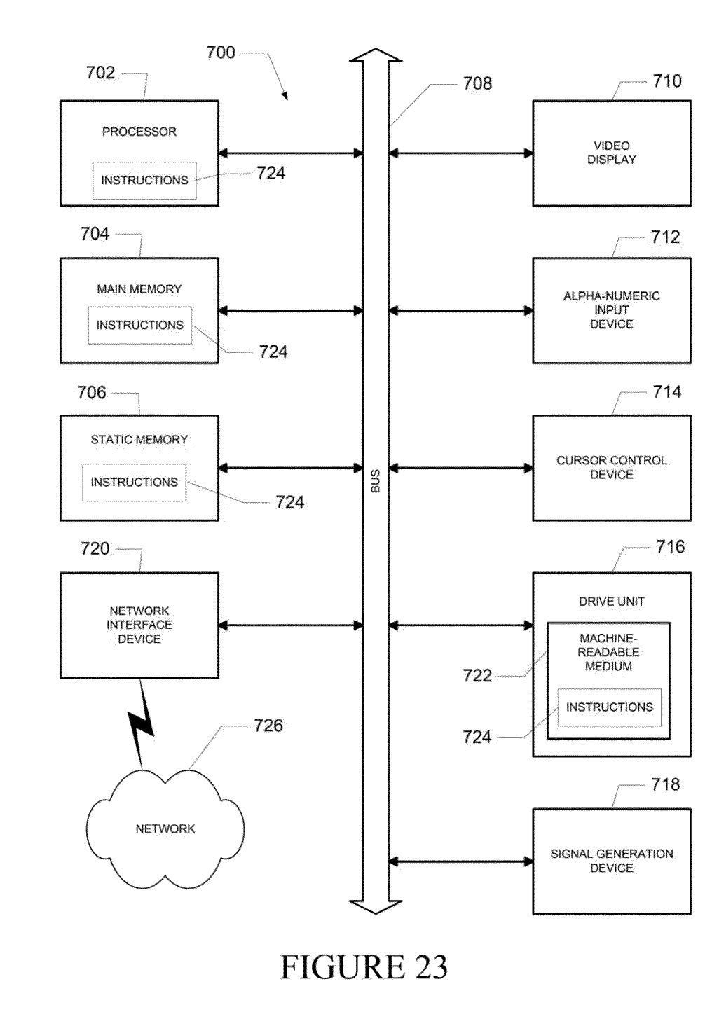

FIG. 23 shows a diagrammatic representation of machine in the example form of a computer system 700 within which a set of instructions when executed may cause the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), at Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” can also be taken to include any collection of machines that individually or jointly execute a set (or multiple sets) of instructions to perform any one or more of the methodologies discussed herein.

The example computer system 700 includes a data processor 702 (e.g., a central processing unit (CPU), a graphics processing unit (GPU), or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an input device 712 (e.g., a keyboard), a cursor control device 714 (e.g., a mouse), a disk drive unit 716, a signal generation device 718 (e.g., a speaker) and a network interface device 720.

The disk drive unit 716 includes a non-transitory machine-readable medium 722 on which is stored one or more sets of instructions (e.g., software 724) embodying any one or more of the methodologies or functions described herein. The instructions 724 may also reside, completely or at least partially, within the main memory 704, the static memory 706, and/or within the processor 702 during execution thereof by the computer system 700. The main memory 704 and the processor 702 also may constitute machine-readable media. The instructions 724 may further be transmitted or received over a network 726 via the network interface device 720. While the machine-readable medium 722 is shown in an example embodiment to be a single medium, the term “machine-readable medium” should be taken to include a single non-transitory medium or multiple media (e.g., a centralized or distributed database, and/or associated caches and servers) that store the one or more sets of instructions. The term “machine-readable medium” can also be taken to include any non-transitory medium that is capable of storing, encoding or carrying a set of instructions for execution by the machine and that cause the machine to perform any one or more of the methodologies of the various embodiments, or that is capable of storing, encoding or carrying data structures utilized by or associated with such a set of instructions. The term “machine-readable medium” can accordingly he taken to include, but not be limited to, solid-state memories, optical media, and magnetic media.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment fir the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A multimedia module connector comprising:
a male portion including an alignment mechanism; and
a female portion configured with a void corresponding in shape to the alignment mechanism of the male portion, the male portion including a plurality of flat electrically conductive contacts integrated into the male portion, the plurality of contacts being configured to make electrical contact with corresponding flat contacts on the female portion when the male portion is inserted into the void of the female portion, the plurality of contacts including a plurality of radio frequency (RF) contacts for transferring RF signals between the male portion and the female portion, the plurality of contacts further including a plurality of data contacts for transferring data signals between the male portion and the female portion, the plurality of contacts being configured to enable a transfer of RF signals and data signals between a multimedia module and one or more vehicle subsystems of a vehicle.

2. The multimedia module connector as claimed in claim 1 wherein the alignment mechanism and the void are configured in the shape of an upside down “U”.

3. The multimedia module connector as claimed in claim 1 wherein the plurality of RF contacts are provided on the left and right sides of the alignment mechanism.

4. The multimedia module connector as claimed in claim 1 wherein the plurality of RF contacts are configured to enable the transfer of the RF signals with minimal insertion loss, crosstalk, and radiation.

5. The multimedia module connector as claimed in claim 1 wherein the plurality of RF contacts are arranged such that any electrical fields generated by the RF signals are perpendicular to any electrical fields generated by the data signals.

6. The multimedia module connector as claimed in claim 1 wherein the alignment mechanism includes a plurality of dielectric tuning notches to enable the transfer of the RF signals with a pre-determined characteristic impedance.

7. The multimedia module connector as claimed in claim 1 wherein at least one of the plurality of contacts being configured as an anti-fretting contact.

8. The multimedia module connector as claimed in claim 7 wherein the at least one of the plurality of contacts configured as an anti-fretting contact is produced with one dimensional features at a connection portion of the contact.

9. The multimedia module connector as claimed in claim 1 wherein the multimedia module connector is a 24-pin connector.

10. The multimedia module connector as claimed in claim 1 wherein at least one of the plurality of contacts is associated with a DisplayPort interface and a different one of the plurality of contacts is associated with a Universal Serial Bus (USB) interface.

11. The multimedia module connector as claimed in claim 1 wherein the male portion of the multimedia module connector is detachable from the female portion.

12. The multimedia module connector as claimed in claim 1 wherein the vehicle subsystems of the vehicle are from the group: an in-vehicle infotainment (IVI) system and an electronic control unit (ECU) of the vehicle.

13. A method comprising:
providing a male portion of as multimedia module connector including an alignment mechanism;
providing a female portion of a multimedia module connector, the female portion being configured with a void corresponding in shape to the alignment mechanism of the male portion, the male portion including a plurality of flat electrically conductive contacts integrated into the male portion, the plurality of contacts being configured to make electrical contact with corresponding flat contacts on the female portion when the male portion is inserted into the void of the female portion, the plurality of contacts including a plurality of radio frequency (RF) contacts for transferring RF signals between the male portion and the female portion, the plurality of contacts further including a plurality of data contacts for transferring data signals between the male portion and the female portion, the plurality of contacts being configured to enable a transfer of RF signals and data signals between a multimedia module and one or more vehicle subsystems of a vehicle; and
detachably connecting the male portion to the female portion.

14. The method as claimed in claim 13 wherein the alignment mechanism and the void are configured in the shape of an upside down “U”.

15. The method as claimed in claim 13 wherein the plurality of RF contacts are provided on the left and right sides of the alignment mechanism.

16. The method as claimed in claim 13 wherein the plurality of RF contacts are configured to enable the transfer of the RF signals with minimal insertion loss, crosstalk, and radiation.

17. The method as claimed in claim 13 wherein the plurality of RF contacts are arranged such that any electrical fields generated by the RF signals are perpendicular to any electrical fields generated by the data signals.

18. The method as claimed in claim 13 wherein the alignment mechanism includes a plurality of dielectric tuning notches to enable the transfer of the RF signals with a pre-determined characteristic impedance.

19. The method as claimed in claim 13 wherein at least one of the plurality of contacts being configured as an anti-fretting contact.

20. The method as claimed in claim 19 wherein the at least one of the plurality of contacts configured as an anti-fretting contact is produced with one dimensional features at a connection portion of the contact.
